(19) United States
(12) Patent Application Publication
(10) Pub. No.: US 2003/0230196 A1
(43) Pub. Date: Dec. 18, 2003

(54) Oxygen supply device

(76) Inventor: Tai-Jin Kim, Seoul (KR)

Correspondence Address: FROMMER LAWRENCE & HAUG, 745 FIFTH AVENUE- 10TH FL., NEW YORK, NY, 10151, US

(21) Appl. No.: 10/463,253

(22) Filed: Jun. 17, 2003

(30) Foreign Application Priority Data
Jun. 18, 2002 (KR) 2002-18504
Oct. 23, 2002 (KR) 2002-64992
Oct. 23, 2002 (KR) 2002-64995

(51) Int. Cl. B01D 53/22

(52) U.S. Cl. 96/4; 96/224; 96/417

(57) ABSTRACT

Provided is an oxygen supply device for common use in a vehicle and indoors, that generates oxygen and supplies the same to the vehicle or a place indoors, and can provide an oxygen concentration display operating in combination with the oxygen supply device for vehicle- or indoor-use. The oxygen supply device for generating oxygen of a constant concentration has a simple structure and operational mechanism and a compact case where various components such as an oxygen separator and a pump mechanism are contained to thereby allow a user to easily mount and dismount the oxygen supply device in and from a vehicle and a place indoors as necessary, and then carry the same by hand. The oxygen supply device has a display for enabling users to verify a current oxygen concentration so the user is reassured. The oxygen supply device does not only dispenses the condensed water generated when generating oxygen under the control of a controller but also automatically removes the condensed water when a vehicle applied with the oxygen supply device stops, thereby enabling ease and convenience of management.

### BACKGROUND OF THE INVENTION

1. Field of the Invention

The present invention relates to an oxygen supply device, and more particularly, to an oxygen supply device for common use in a vehicle and a place indoors, that generates oxygen and supplies the same to the vehicle or a place indoors, in which an oxygen concentration display can be provided for operating in combination with the oxygen supply device for vehicle- or indoor-use.

2. Description of the Related Art

In a case where a heater or an air-conditioner is operated at the state where a ventilation means or window is closed in a vehicle or partitioned room as is well-known, air in the vehicle or in the partitioned room becomes dirty within a short period of time and the oxygen concentration becomes remarkably lower. Such air pollution and lowering of oxygen concentration can make passengers including a vehicle driver or indoor residents feel fatigue or discomfort easily. Accordingly, air-conditioning systems, such as various air cleaning devices or oxygen generators, can be installed in a vehicle or a place indoors.

The oxygen generator is a mechanical device for separating oxygen from air that has been taken in and supplying the separated oxygen inside of the vehicle or room. Most of the conventional oxygen generators adopt a pressure swing adsorption (PSA) method. In the PSA method, oxygen is obtained when air passes alternately through two columns in which zeolite is charged. In this case, since the structure is complicated and the weight is very heavy, the oxygen generator should be fixedly installed and used in a certain place due to the limited possibilities of installation and the difficulty in moving and removing the same.

Also, since the oxygen generator does not display an indoor oxygen concentration level, users cannot verify whether they are in an environmental state of a normal oxygen concentration or an environmental state of optimal oxygen concentration. In this respect, the oxygen generator cannot provide sufficient physical and psychological satisfaction to users.

In addition, since the PSA method oxygen generator should counter-clean zeolite adsorbing oxygen, the oxygen production amount is not great in comparison with the system size and the oxygen concentration is not always constant.

### SUMMARY OF THE INVENTION

To solve the above problems, it is an aspect of the present invention to provide an oxygen supply device for generating oxygen of a constant concentration with a simple structure and operational mechanism, as well as a compact case where various components, such as an oxygen separator and a pump mechanism, are contained to thereby allow a user to easily mount and dismount the oxygen supply device in and from a vehicle and a room as necessary to facilitate hand-carrying thereof.

It is another aspect of the present invention to provide an oxygen supply device having a display for enabling users to verify a current oxygen concentration to ease the users.

It is still another aspect of the present invention to provide an oxygen supply device not only for discharging condensed water generated during oxygen generation under the control of a controller but also for automatically dispensing the condensed water when a vehicle supplied with the oxygen supply device stops, thereby simplifying management.

To accomplish the above aspect of the present invention, there is provided an oxygen supply device comprising: an oxygen generator installed in a case having an air inflow inlet and an oxygen discharging outlet, wherein said oxygen generator comprises: a pump for receiving external air through the air inflow tube and pumping the air flowing in the air inflow tube, after being activated by an applied external power source; an oxygen separator connected to the pump, through which air discharged from the pump to pass and oxygen is separated and generated from the air to be discharged through the oxygen discharging tube; a wet oxygen prevention unit for preventing water drops from being discharged through the oxygen discharging tube; and a controller for controlling the pump and the wet oxygen prevention unit.

Also, the oxygen supply device further comprises an oxygen concentration sensor for sensing an indoor oxygen concentration when oxygen produced from the oxygen generator is supplied and a display connected to the oxygen concentration sensor for displaying the sensed oxygen concentration thereon.

Also, a percentage value of an oxygen concentration ratio of a current oxygen concentration with respect to a desired oxygen concentration is displayed on the display.

Also, the oxygen supply device further comprises a manipulator for sending a control signal to the controller so as to perform a predetermined control operation.

Also, the manipulator and the display are connected with each other to form a control panel, in which a desired oxygen concentration input button for inputting a desired oxygen concentration into the controller is provided on the manipulator and at least one display window for displaying an oxygen concentration thereon is provided on the display.

Also, the wet oxygen prevention unit comprises a condensed water trap through which oxygen separated by the oxygen separator passes and for separating condensed water generated due to a variation in an oxygen pressure from the passing oxygen to thereby transfer the moisture removed oxygen to the oxygen discharging tube; and a condensed water drainage valve, which is closed when power is applied and open when power is not applied, for dispensing the condensed water collected in the condensed water trap.

In addition, the wet oxygen prevention unit is a heater, which is installed between the pump and the oxygen separator, for heating the air flowing into the oxygen separator so as to prevent condensed water from being produced by the oxygen pressure variation.

Also, the oxygen supply device further comprises a second pump, which is installed between the oxygen separator and the oxygen discharging tube, for taking in the oxygen discharged from the oxygen separator and transferring the oxygen that has been taken in to the oxygen discharging tube.

Also, the oxygen supply device further comprises at least one ultraviolet sterilizer for sterilizing bacteria in the air or oxygen in the oxygen supply device so that the oxygen discharged through the oxygen discharging tube is purified.

Also, an oxygen supply line for transferring oxygen to a place where oxygen is needed is connected to the oxygen discharging tube.

Also, the oxygen supply line is configured so that an end of the oxygen supply line is extended into an air discharging grill to thereby discharge oxygen through the grill when the oxygen supply device is applied to a vehicle.

Also, the oxygen supply line comprises at least one diffusion nozzle, which is installed on the inner ceiling on the driver's side, for spraying oxygen downwards when the oxygen supply device is applied to a vehicle.

Also, the oxygen supply line is configured so that an end of the oxygen supply line is extended toward a sun visor at the upper portion of a driver's seat to thereby discharge oxygen from the sun visor, in which the oxygen concentration sensor is installed on the control panel.

Also, a second condensed water trap for collecting and dispensing the condensed water produced in the inside of the oxygen supply line is further provided in a predetermined place along the oxygen supply line.

Also, the control panel is fixed to the sun visor and an end of the oxygen supply line is fixed to the control panel.

In addition, an end of the oxygen supply line passes through the inside of the control panel and is connected to a flexible tube with which a discharging direction of oxygen can be adjusted in a desired direction.

Also, the manipulator further comprises a warning lamp for informing a user that the condensed water should be emptied from the condensed water trap, and a condensed water drainage button for disconnecting power applied to the condensed water drainage valve via the controller to thereby open the condensed water drainage valve.

Also, the manipulator further comprises a heater on/off button for turning the heater on or off via the controller.

In addition, the power applied to the controller in the oxygen generator is a commercialized alternating-current (AC) power.

Accordingly, an inverter for inverting an externally supplied direct-current (DC) power into an AC power is further provided in the oxygen supply device when the oxygen supply device is applied to a vehicle.

Also, the oxygen separator is a hollow thread-film or flat-film oxygen separator.

Also, a discharged oxygen concentration sensor for sensing the concentration of the oxygen discharged through the oxygen discharging tube and transferring the sensed oxygen concentration to the controller so as to be displayed on the display is provided in a place along the oxygen discharging tube in the oxygen generator.

### BRIEF DESCRIPTION OF THE DRAWINGS

The above aspects and other advantages of the present invention will become more apparent by describing the preferred embodiments thereof in greater detail with reference to the accompanying drawings in which:

FIG. 1 is a schematic configurational diagram explaining a basic configuration of an oxygen supply device according to the present invention;

FIG. 2 shows an example of a power source for use with an oxygen supply device according to the present invention;

FIG. 3 shows another example of a power source for use with an oxygen supply device according to the present invention;

FIGS. 4A and 4B are schematic configurational diagrams showing examples when each oxygen supply device according to the first and second embodiments of the present invention is applied to a vehicle;

FIGS. 5A and 5B are schematic configurational diagrams showing other examples when each oxygen supply device according to the first and second embodiments of the present invention is applied to a vehicle;

FIGS. 6A and 6B are schematic configurational diagrams showing still other examples when each oxygen supply device according to the first and second embodiments of the present invention is applied to a vehicle;

FIG. 7A is a detailed diagram showing a control panel respectively shown in FIGS. 4A through 6B;

FIG. 7B is a side view showing a control panel of FIGS. 4A through 6B which is installed on a sun visor;

FIG. 8 is a schematic diagram explaining the inner structure of an oxygen generator in each of the oxygen supply devices according to the first and second embodiments of the present invention;

FIG. 9 is a schematic diagram explaining the inner structure of another oxygen generator in each of the oxygen supply devices according to the first and second embodiments of the present invention, differing from the FIG. 8 oxygen generator;

FIG. 10 is a schematic diagram explaining the inner structure of still another oxygen generator in each of the oxygen supply devices according to the first and second embodiments of the present invention, which differs from the FIG. 8 oxygen generator;

FIG. 11 is a schematic diagram explaining the inner structure of yet another oxygen generator in each of the oxygen supply devices according to the first and second embodiments of the present invention, differing from the FIG. 8 oxygen generator;

FIG. 12 is a schematic diagram explaining the inner structure of another oxygen generator in each of the oxygen supply devices according to the first and second embodiments of the present invention, differing from the FIG. 11 oxygen generator;

FIG. 13 is a schematic diagram explaining the inner structure of still another oxygen generator in each of the oxygen supply devices according to the first and second embodiments of the present invention, differing from the FIG. 11 oxygen generator;

FIG. 14 is a schematic diagram explaining the structure of a condensed water trap respectively shown in FIGS. 8 through 13;

FIGS. 15A and 15B are schematic configurational diagrams showing examples when each oxygen supply device according to the third and fourth embodiments of the present invention is applied to a vehicle;

FIGS. 16A and 16B are schematic configurational diagrams showing other examples when each oxygen supply device according to the third and fourth embodiments of the present invention is applied to a vehicle;

FIGS. 17A and 17B are schematic configurational diagrams showing still other examples when each oxygen supply device according to the third and fourth embodiments of the present invention is applied to a vehicle;

FIG. 18 is a detailed diagram showing a control panel respectively shown in FIGS. 15A through 17B;

FIG. 19 is a schematic diagram explaining the inner structure of an oxygen generator in each of the oxygen supply devices according to the third and fourth embodiments of the present invention;

FIG. 20 is a schematic diagram explaining the inner structure of another oxygen generator in each of the oxygen supply devices according to the third and fourth embodiments of the present invention, differig from the FIG. 19 oxygen generator;

FIG. 21 is a schematic diagram explaining the inner structure of still another oxygen generator in each of the oxygen supply devices according to the third and fourth embodiments of the present invention, differing from the FIG. 19 oxygen generator;

FIG. 22 is a schematic diagram explaining the inner structure of yet another oxygen generator in each of the oxygen supply devices according to the third and fourth embodiments of the present invention, differing from the FIG. 19 oxygen generator;

FIG. 23 is a schematic diagram explaining the inner structure of still yet another oxygen generator in each of the oxygen supply devices according to the third and fourth embodiments of the present invention, differing from the FIG. 19 oxygen generator;

FIG. 24 is a schematic diagram explaining the inner structure of a further oxygen generator in each of the oxygen supply devices according to the third and fourth embodiments of the present invention, differing from the FIG. 19 oxygen generator;

FIGS. 25A and 25B are schematic configurational diagrams showing examples when each oxygen supply device according to the first through fourth embodiments of the present invention is applied in an indoor environment; and

FIGS. 26A and 26B are detailed diagrams showing another control panel which can be applied to an oxygen supply device of the present invention.

### DETAILED DESCRIPTION OF THE INVENTION

Preferred embodiments of the present invention will be described with reference to the accompanying drawings.

In general, an oxygen supply device according to the present invention can be easily mounted at a particular place and dismounted from that place to be mounted at another place. For example, the oxygen supply device can be used in a living room or a study or library as well as in a vehicle. Also, a display to be described later displays the current indoor oxygen concentration as a percentage on the basis of an oxygen concentration of 20.9%, to thereby provide users with an ease in recognizing an oxygen concentration.

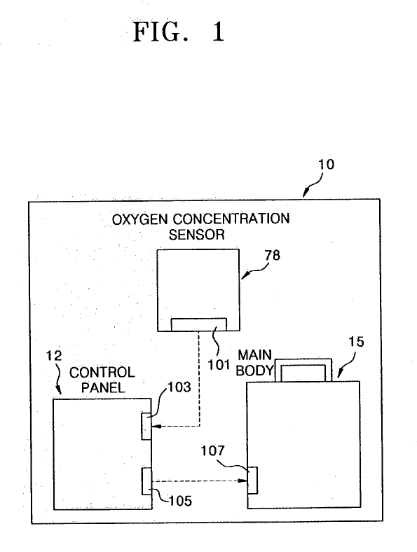

FIG. 1 is a schematic configurational diagram explaining a basic configuration of an oxygen supply device according to the present invention.

As shown in FIG. 1, an oxygen supply device 10 according to the present invention includes an oxygen generator 15, which generates oxygen, a control panel 12 which sends a control signal to the oxygen generator 15 and an oxygen concentration sensor 78 which senses the oxygen concentration of the air indoors and transfers the sensed oxygen concentration to the control panel 12.

The oxygen concentration sensor 78 can be positioned in a place desired by the user. Here, the oxygen concentration sensor 78 can be fixed to the control panel 12. As will be described later, the control panel 12 includes a display and a manipulator.

For mutual signal transmission among the oxygen generator 15, the control panel 12, and the oxygen concentration sensor 78, the oxygen concentration sensor 78 includes a signal transmitter 101 for transmitting the sensed oxygen concentration to the control panel 12; the control panel 12 includes a signal receiver 103 for receiving the oxygen concentration transmitted from the oxygen concentration sensor 78 and a signal transmitter 105 for generating and transmitting a control signal for controlling the oxygen generator 15; and the oxygen generator 15 includes a signal receiver 107 for receiving the control signal from the control panel 12.

Here, the signal transmission method among the oxygen generator 15, the control panel 12, and the oxygen concentration sensor 78, can be put into effect by using a well-known wired or wireless communication method.

Finally, the oxygen generator 15 in the oxygen supply device 10 according to the present invention generates oxygen, and the control panel 12 controls the amount of oxygen of the oxygen generator 15 and displays the current oxygen concentration in the air, while the oxygen concentration sensor 78 senses the oxygen concentration in the air so as to be displayed on the display in the control panel 12.

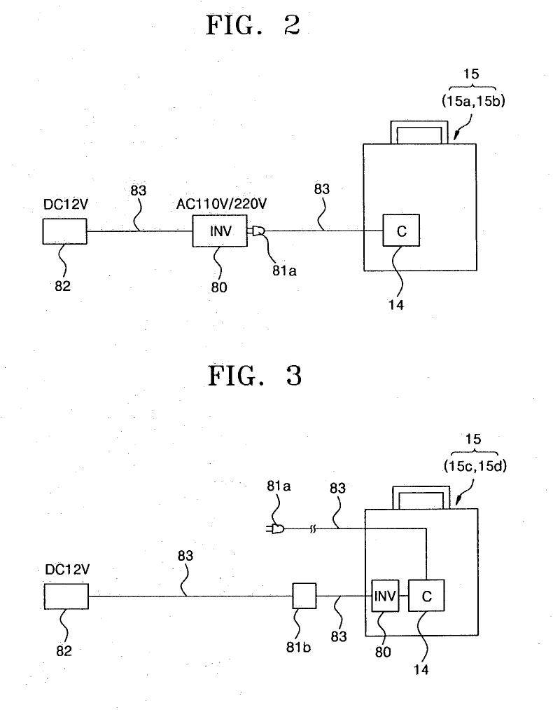

FIG. 2 shows an example of a power source for use with an oxygen supply device according to the present invention, and FIG. 3 shows another example of a power source for use with an oxygen supply device according to the present invention.

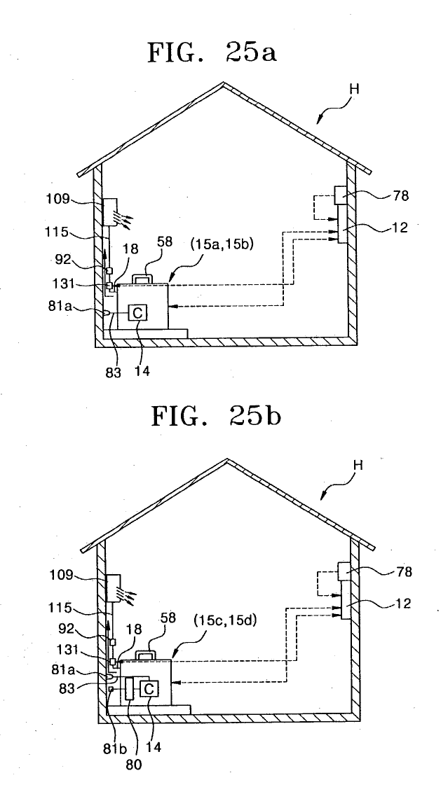

In general, the oxygen supply device 10 according to the present invention can use a commercialized alternating-current (AC) voltage, e. g., AC 100V or 220V. That is, a controller 14, and a pump or heater, which are provided in the oxygen generator 15 will be described later, are controlled by the controller 14, and powered at AC 110V or 220V. For this purpose, the controller 14 in the oxygen generator 15 is configured to directly receive an external power through a power cable 83 and a connector 81a from an external power source such as an inverter 80. The connector 81a is a well-known plug that can be plugged directly into an outlet (not shown) on a wall as shown in FIGS. 25A and 25B.

In FIG. 2, the oxygen supply device 10 is connected to a power supply generating direct-current (DC) power, in which the power supply is a cigarette jack port 82 in a vehicle.

Referring to FIG. 2, the oxygen generator 15 is connected to a cigarette jack port 82 via an inverter 80 to which the oxygen generator 15 is connected via the connector 81a and the power cable 83, and the inverter 80 is connected to the cigarette jack port 82 via the power cable 83. If the connector 81a is separated from the external inverter 80 in FIG. 2, the oxygen generator 15 can be removed from a vehicle and installed somewhere other than the vehicle.

The inverter is a well-known inverting device for inverting a DC 12V into an AC 110V or 220V. Here, the AC 110V or 220V is transferred to the controller 14. Thus, the oxygen supply device 10 according to the present invention receives a voltage supplied from the cigarette jack port 82 and then operates.

In FIG. 2, the inverter 80 used for supplying a voltage to the oxygen generator 15 is installed outside of the oxygen generator 15. However, in FIG. 3, the inverter 80 is installed within the oxygen generator 15.

In particular, as shown in FIG. 3, the inverter 80 installed within the oxygen generator 15 is connected to the controller 14 in the oxygen generator 15. In addition, the controller 14 can further include an externally extended power cable 83 and a connector 81a so as to receive AC power from an external power source.

Meanwhile, the cigarette jack port 82 and the inverter 80 are connected to each other via the power cable 83. Thus, the DC voltage supplied from the cigarette jack port 82 is supplied to the inverter 80 in the oxygen generator 15 via the power cable 83 and then inverted into AC voltage by the inverter 80 to then be supplied to the controller 14. The power cable 83 connected to the inverter 80 can be connected to or isolated from the external power source by a connector 81b. The connector 81b is a well-known connection component.

If the connector 81b is separated from the external power source such as a cigarette jack port 82 in FIG. 3, the oxygen generator 15 can be removed from a vehicle and installed somewhere other than the vehicle.

In FIG. 3, the oxygen generator 15 of the oxygen supply device 10 possesses two connectors 81a and 81b. The two connectors are alternatively used, such that one connector 81a is a plug fitted into an outlet in order to directly receive an external AC voltage, and the other connector 81b is a connector for receiving a DC voltage from the cigarette jack port 82.

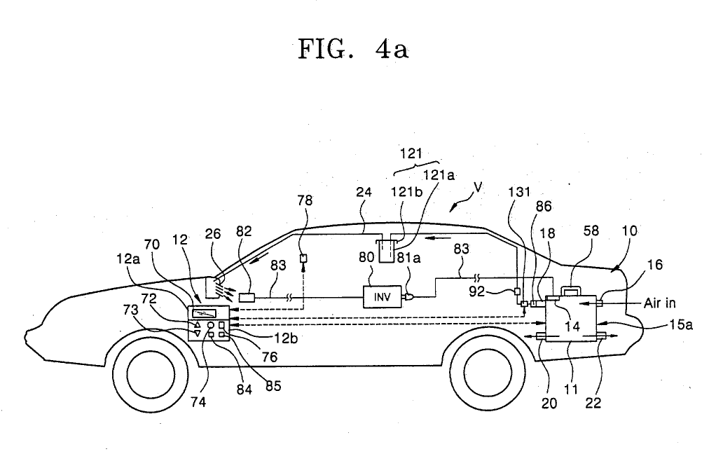

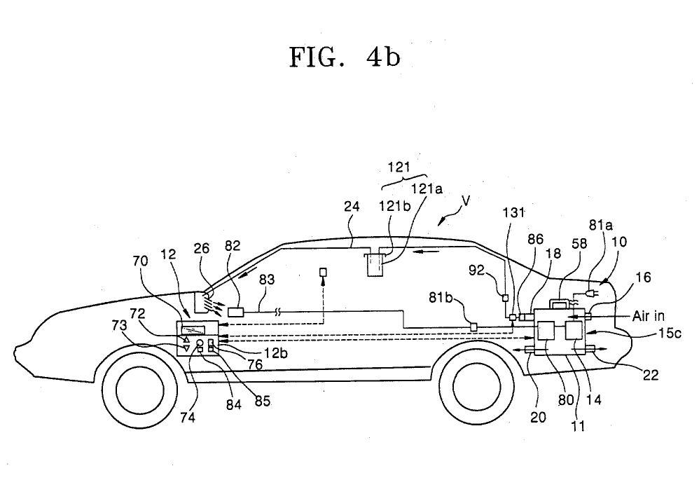

FIGS. 4A through 6B are schematic configurational diagrams showing various examples when each oxygen supply device according to the first and second embodiments of the present invention is applied to a vehicle.

In FIGS. 4A, 5A, and 6A, an oxygen supply device having a power supply mode shown in FIG. 2 is shown respectively. In FIGS. 4B, 5B and 6B, an oxygen supply device having a power supplying mode shown in FIG. 3 is shown respectively.

Referring to FIG. 4A, an oxygen supply device 10 according to a first embodiment of the present invention includes an oxygen generator 15a installed in a trunk of a vehicle V for supplying oxygen into the inside of the vehicle through an oxygen supply line 24; a control panel 12 connected to the oxygen generator 15a by a wire or wirelessly for controlling the oxygen generator 15a; a power supply for supplying a voltage from the cigarette jack port 82 to the oxygen generator 15a; and an oxygen concentration sensor 78 for sensing an indoor oxygen concentration.

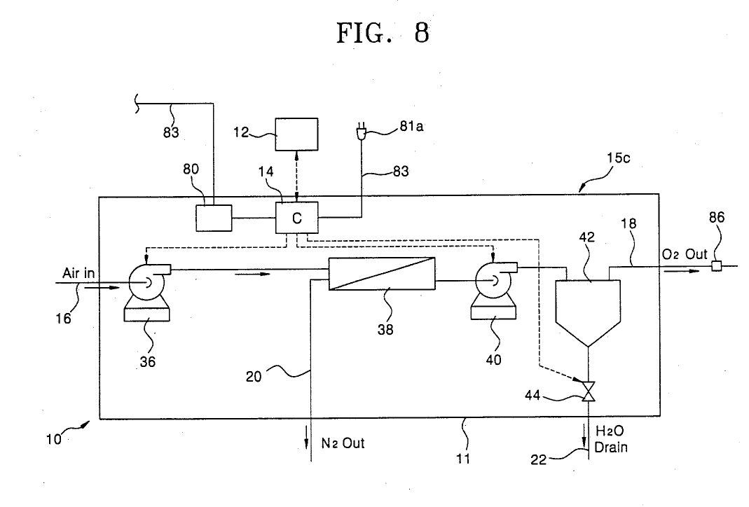

The oxygen generator 15a in the oxygen supply device 10 has a basic operational mechanism, which receives outside air through an air inflow tube 16, so that it passes through an oxygen separator 38 shown in FIG. 8 to be described later, and thus separates oxygen from the received air, and supplies the separated oxygen to a place requiring oxygen through an oxygen discharging tube 18.

The position where the oxygen generator 15a is installed varies according to the type of vehicle. For example, for a freight vehicle, the oxygen generator 15a can be installed in a rear-side loading cabinet. In addition, the control panel 12 is positioned close to the driver's seat to allow a driver to easily manipulate it.

The oxygen generator 15a is connected to a cigarette jack port 82 through a power cable 83, the inverter 80, and a connector 81a. Thus, the oxygen generator 15a receives an AC voltage inverted from the DC voltage by the inverter 80 and then operates.

Also, as will be described later, the components of the oxygen generator 15a are contained in a case 11. Thus, if the connector 81a is separated from the inverter 80 and a connector 92 for connecting an oxygen discharging tube 18 to an oxygen supply line 24 is also separated from the oxygen supply line 24, a user can take hold of a grip 58 of the case 11 and transfer the oxygen generator 15a from the trunk of the vehicle to another place after the oxygen generator 15a has been dismantled from the trunk.

The air inflow tube 16 is connected to pumps 36 and 48 in the case 11 to be described later, in order to take in outside air into the case 11. Also, the oxygen discharging tube 18 is connected to the oxygen supply line 24 via the connector 92, so that oxygen generated from the oxygen generator 15a is supplied to a desired place via the oxygen supply line 24.

Also, an aromatic diffuser 86 and a discharged oxygen concentration sensor 131 are additionally provided along the oxygen discharging tube 18. The aromatic diffuser 86 contains aromatic materials for generating various kinds of fragrances and is opened in a passage through which oxygen flows toward the oxygen supply line 24 to thereby aromatize the flowing oxygen that spreads throughout the indoor areas.

The discharged oxygen concentration sensor 131 senses the oxygen concentration of the oxygen discharged through the oxygen discharging tube 18 and transfers the sensed result to the control panel 12 to be described later. The discharged oxygen concentration sensor 131 is connected to the control panel 12 by a wire or wirelessly.

A nitrogen discharging tube 20 and a condensed water drainage tube 22 are further provided in the oxygen generator 15a. The nitrogen discharging tube 20 is connected to an oxygen separator 38 to be described later, for outwardly discharging air (mostly nitrogen gas), which does not pass the oxygen separator 38. Also, a condensed water drain tube 22 is connected to a condensed water trap 42 of FIG. 8 as shown in FIG. 8, for externally draining the condensed water generated during the generation of oxygen.

Meanwhile, the indoor oxygen concentration sensor 78 is a well-known oxygen concentration sensor for sensing indoor oxygen concentration and may be installed at a height near the driver's head, or positioned on a sun visor located in the upper-front position from a driver's seat.

The oxygen concentration sensor 78 is connected to the control panel 12 by a wire or wirelessly, so that a current indoor oxygen concentration can be displayed on a display window 70 of the control panel 12. A plurality of oxygen concentration sensors 78 can be installed.

The control panel 12 includes a display 12a and a manipulator 12b. The display 12a displays oxygen concentration values sensed by the oxygen concentration sensor 78 and the discharged oxygen concentration sensor 131, and is connected to the manipulator 12b which indicates a desired oxygen concentration on the display 12a whenever desired oxygen concentration input buttons 72 and 73 are pressed on the manipulator 12b. A liquid display device (LCD) can be applied as a display window 70 of the display 12a.

The display window 70 displays the oxygen concentration values sensed by the oxygen concentration sensors 78 and 131 thereon, to thereby provide a reference for making a driver when controlling the controller 14 to increase or decrease the amount of oxygen produced.

In particular, an indoor oxygen concentration displayed on the display window 70 after being sensed by the oxygen concentration sensor 78 is indicated as a percentage. The oxygen percentage is obtained by calculating a formula, that is, a current indoor oxygen concentration divided by a driver's desired oxygen concentration multiplied by 100. Here, the driver's desired oxygen concentration is input in advance to the controller 14 through the desired oxygen concentration input buttons 72 and 73 on the manipulator 12b.

Thus, in a case where a driver's desired indoor oxygen concentration is 20.9% and an indoor oxygen concentration sensed by the oxygen concentration sensor 78 is 20.0%, the oxygen percentage is 96% using the above forrnula, and thus, a figure of 96 is displayed on the display window 70.

Likewise, in a case where an actual indoor oxygen concentration is 21.7%, a figure of a displayed oxygen concentration value becomes 104% which exceeds a figure of 100.

That is, a displayed figure exceeding a figure of 100 means that an actual oxygen concentration is higher than a driver's desired oxygen concentration. A displayed figure less than a figure of 100 means that an actual oxygen concentration is lower than a driver's desired oxygen concentration. As a result, the driver can easily recognize the current oxygen concentration to thereby make proper adjustments.

Although the manipulator 12b can be combined with the display 12a as shown in this embodiment, the display 12a and the manipulator 12b can also be formed separately.

The manipulator 12b is connected to a signal receiver 107 in the oxygen generator 15a of FIG. 1 by a wire or wirelessly, to thereby send a signal to the controller 14 control the amount of oxygen produced in the oxygen separator 38 and a condensed water drain valve 44 of FIG. 8 as well.

On the front surface of the manipulator 12b are provided a warning lamp 74, a condensed water drainage button 76, a set button 84, and a reset button 85 in addition to the desired oxygen concentration input buttons 72 and 73.

The desired oxygen concentration input buttons 72 and 73 are input buttons for inputting desired oxygen concentration values into the controller 14. When the desired oxygen concentration input buttons 72 and 73 are pressed, a figure is displayed on the display window 70, to thereby enable an operator such as a driver to increase or decrease the figure for a desired oxygen concentration.

Also, the set button 84 is a button for setting and storing a figure determined by the desired oxygen concentration input buttons 72 and 73, so that the controller 14 stores the desired oxygen concentration. The reset button 85 is a button for changing the set figure. That is, after pressing the reset button 85, an oxygen concentration of a desired figure can be set by increasing or decreasing a figure while pressing the desired oxygen concentration input buttons 72 and 73.

A circuitry configuration including the desired oxygen concentration input buttons 72 and 73, the set button 84 and the reset button 85 can be easily implemented by one skilled in the art with basic circuitry knowledge. Accordingly, a circuitry configuration providing an identical function can be modified in various forms.

The warning lamp 74 is a lamp for informing a driver of a time when condensed water contained in a condensed water trap 42 of FIG. 8 to be described later is to be drained. For example, when a level of the condensed water reaches electrodes 52 of FIG. 14, the warning lamp 74 is lit. All other times, the warning lamp 74 is not lit.

The condensed water drainage button 76 provided next to the warning lamp 74 is a button for opening a condensed water drainage valve 44 of FIG. 14 to be described later. As described above, the condensed water drainage valve 44 is a valve which stays closed when power is supplied from an external power source. Accordingly, when the condensed water drainage button 76 has been pressed, power supplied to the condensed water drainage valve 44 is interrupted. A circuitry configuration for interrupting power supplied to the condensed water drainage valve 44 when the condensed water drainage button 76 can be implemented by a person who has an ordinary skill in the art with basic circuitry knowledge.

As described above, the control panel 12 is installed near a driver when the oxygen supply device 10 is used in a vehicle, so that the driver can manipulate the control panel 12 conveniently. When the oxygen supply device 10 is used indoors as shown in FIGS. 25A and 25B, the position of the control panel 12 can be freely selected as far as the oxygen supply device can still be controlled.

The oxygen supply line 24 is a passage for supplying oxygen produced in the oxygen generator 15a to a place requiring oxygen. In this embodiment, the oxygen supply line 24 is installed adjacent to the ceiling above the driver's seat in the inside of a vehicle V. The oxygen supply line 24 is connected to the oxygen discharging tube 18 by the connector 92 but can be separated from the oxygen discharging tube 18 when necessary as described above.

The oxygen supply line 24 passes through the indoor ceiling so that one end of the oxygen supply line 24 is extended to the inside of a grill 26 provided in a surface in front of the driver's seat. Thus, the oxygen generated from the oxygen generator 15a is supplied indoors through the grill 26. In this case, an air-conditioner or heater can be operated together with the oxygen supply device.

In addition, a second condensed water trap 121 is additionally installed on the oxygen supply line 24. The second condensed water trap 121 is prepared for gathering condensed water which can be generated from oxygen passing through the oxygen supply line 24. A basic function of the second condensed water trap 121 is the same as that of the typical condensed water trap.

The second condensed water trap 121 includes a sealing case 121a in which condensed water is collected. The oxygen supply line 24 is inserted into the sealing case 121a at a state where a certain portion of the oxygen supply line 24 has been cut off. The sealing case 121a is sealed by a sealing cap 121b.

Accordingly, oxygen flowing through the oxygen supply line 24 passes through the sealing case 121a. In this case, if condensed water is produced, the produced condensed water is collected in the sealing case 121a due to gravitational force.

Meanwhile, the second condensed water trap 121 can be installed at a place desired by the user. However, it is preferable that the second condensed water trap 121 is installed in the lower portion of a driver's seat so the driver can easily manage the condensed water.

The driver separates the sealing case 121a from the sealing cap 121b manually in order to empty the condensed water collected in the sealing case 121a.

FIG. 4B shows an oxygen supply device employing a power supplying mode shown in FIG. 3.

Hereafter, the same reference numerals as those of FIG. 4A indicate the same members having the same functions as those of FIG. 4A. Thus, the detailed descriptions thereof will be omitted.

Referring to FIG. 4B, an inverter 80 is installed in a case 11. The inverter 80 receives a DC voltage from a cigarette jack port 82 as shown in FIG. 3 and inverts the received DC voltage into an AC voltage. An oxygen generator 15c operates under the AC voltage. Here, a connector 81a for directly receiving an AC voltage from an external power source is not plugged into an outlet.

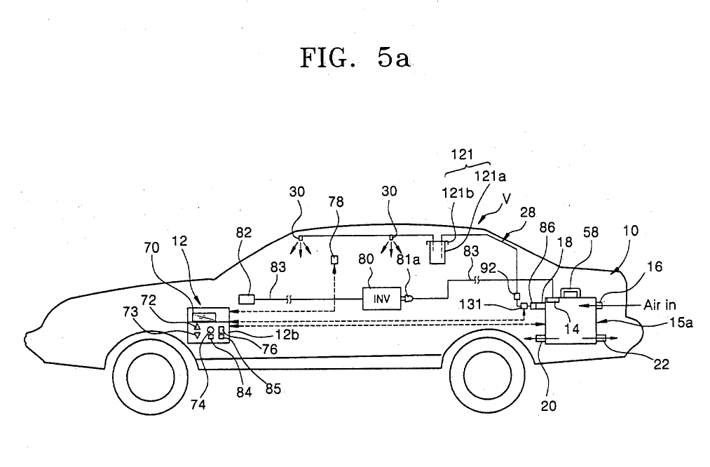

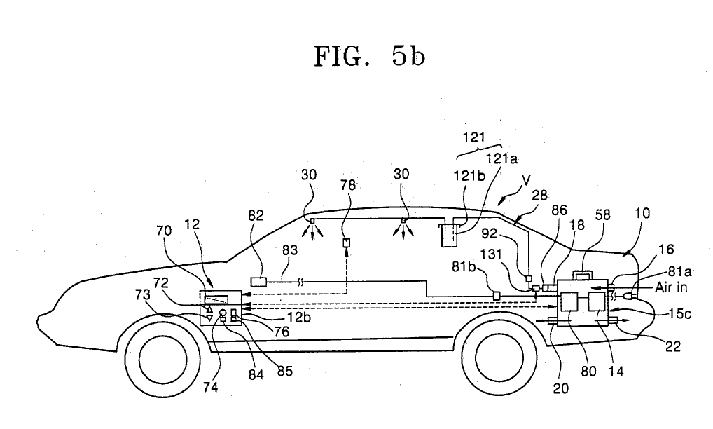

FIGS. 5A and 5B are schematic configurational diagrams showing other examples when each oxygen supply device according to the first and second embodiments of the present invention is applied to a vehicle.

FIG. 5A shows an oxygen supply device having a power supply mode shown in FIG. 2, and FIG. 5B shows an oxygen supply device having a power supply mode shown in FIG. 3.

Referring to FIGS. 5A and 5B, an oxygen supply line 28 is installed along an inner ceiling and includes a plurality of diffusion nozzles 30 for spraying oxygen downwards. The diffusion nozzles 30 are well-known nozzles for spraying oxygen flowing through an oxygen supply line 28 in a downward direction. The number of the diffusion nozzles 30 installed along the oxygen supply line 28 can be varied according to different design criteria.

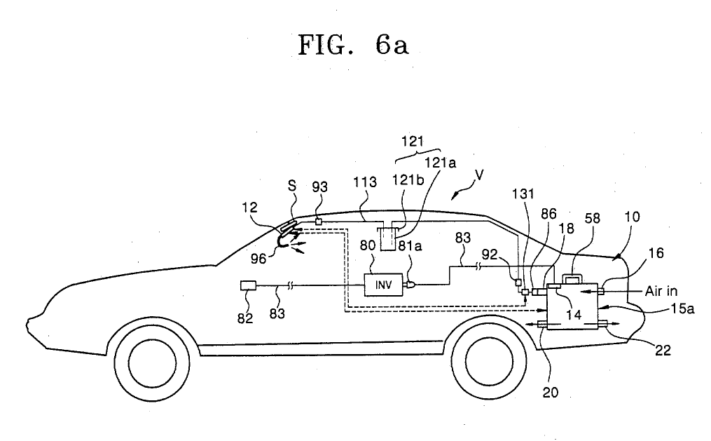

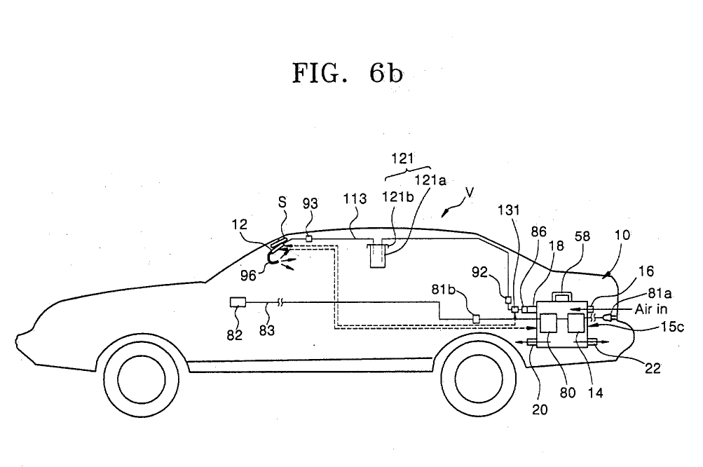

FIGS. 6A and 6B are schematic configurational diagrams showing still other examples when each oxygen supply device according to the first and second embodiments of the present invention is applied to a vehicle.

FIG. 6A shows an oxygen supply device having a power supply mode shown in FIG. 2, and FIG. 6B shows an oxygen supply device having a power supply mode shown in FIG. 3.

Referring to FIGS. 6A and 6B, a control panel 12 is fitted onto a sun visor S. The function of the control panel 12 is the same as those of FIGS. 4A to 5B.

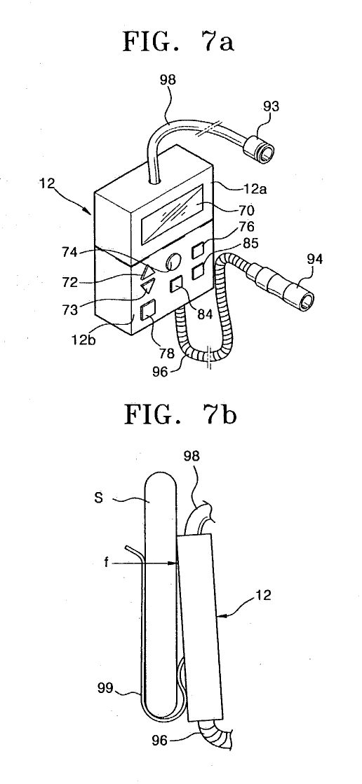

FIG. 7A is a detailed diagram showing a control panel respectively shown in FIGS. 4A through 6B. FIG. 7B is a side view showing a control panel of FIGS. 4A through 6B which is installed on a sun visor.

As shown in FIG. 7A, an oxygen concentration sensor 78 is installed on the front surface of a manipulator 12b. The basic function of the oxygen concentration sensor 78 is the same as those used in the oxygen supply devices shown in FIGS. 4A through 6B.

Referring back to FIGS. 6A and 6B, the oxygen supply line 113 for transferring oxygen produced indoors by each of the respective oxygen generators 15a and 15c is positioned near the ceiling indoors, and one end of the oxygen supply line 113 is extended toward a sun visor S. Next, the oxygen supply line 113 is connected to a flexible tube 96 through the control panel 12.

The flexible tube 96 is a well-known tube which can be freely bent in any direction and then be maintained at the bent state. As shown in FIG. 7A, an oxygen spraying exit 94 is provided on one end of the flexible tube 96.

A reference numeral 93 denotes a connector. The connector 93 is a connection unit for connecting and disconnecting the control panel 12 to and from the oxygen supply line 113, respectively.

FIG. 7A is a schematic perspective view showing a control panel of FIGS. 6A and 6B, respectively.

As shown in FIG. 7A, a connection tube 98 is provided on the upper portion of the control panel 12. The connection tube 98 is upwardly connected to the oxygen supply line 113 via the connector 93 and is connected to the flexible tube 96 through the control panel 12 downwards.

The connection tube 98 can be installed so as to pass through the control panel 12 unless the former obstructs the inner circuitry configuration of the latter. However, if the connection tube 98 obstructs the inner circuitry configuration of the control panel 12, the connection tube 98 can be installed via a roundabout route of the control pane 12.

The flexible tube 96 is a metallic tube which can be bent in any direction and maintain a bent state. The oxygen spraying exit 94 provided on the lower end of the flexible tube 96 is a well-known diffusion nozzle for spraying oxygen more widely.

In addition, an oxygen concentration sensor 78 is installed on the front surface of the control panel 12. The oxygen concentration sensor 78 senses the oxygen concentration near a sun visor S and transfers the sensed result so as to be displayed on a display window 70 of a display 12a. That is, an oxygen concentration value is displayed on the display window 70.

Meanwhile, as shown in FIG. 7B, a clip 99 is provided on the rear portion of the control panel 12 so the control panel 12 can be fixed to the sun visor S. The clip 99 provides an elastic force in the direction of the arrow f and presses the sun visor when the control panel 12 is fitted on the sun visor S, to thereby temporarily fix the control panel 12 to the sun visor S.

FIGS. 8 through 13 are schematic diagrams for explaining the inner structure of an oxygen generator in each of the oxygen supply devices according to the first and second embodiments of the present invention. In FIGS. 8 through 13, an inverter 80 is installed in an oxygen supply device 15c which has already been described with reference to FIG. 3. The FIGS. 8 through 13 oxygen generators are same as that of FIG. 2, if the inverter 80 is excluded from the respective oxygen generators of FIGS. 8 through 13.

Referring to FIG. 8, an oxygen generator 15c in an oxygen supply device 10 according to a second embodiment of the present invention is installed in a case 11, which has an air inflow inlet 16 and an oxygen discharging outlet 18, for providing an inner space for installing each component therein, in which the oxygen generator includes a first pump 36 for receiving external air through the air inflow tube 16, an oxygen separator 38 connected to the first pump 36 through which air discharged from the first pump 36 passes and oxygen is separated and generated from the air so that a gas other than oxygen can be discharged through a nitrogen discharging tube 20, a second pump 40 connected to the oxygen separator 38, for transferring oxygen separated by the oxygen separator, a condensed water trap 42, which is connected to the second pump 40, including a condensed water drainage valve 44 positioned on the lower portion of the condensed water trap 42 for separating the condensed water generated during oxygen generation and collecting the same therein, and a controller 14 for controlling the pumps 36 and 40 and the condensed water trap 42.

The condensed water trap 42 is an embodiment of a wet oxygen prevention unit for preventing water drops from being discharged through the oxygen discharging tube 18. Instead of the condensed water trap 42, a heater, an evaporator, and so on can be adopted along the air inlet tube or the oxygen outlet tube.

The first and second pumps 36 and 40 can each adopt a well-known centrifugal pump.

The controller 14 receives an AC power through an inverter 80 or a connector 81a and then controls operations of the pumps 36 and 40 and the condensed water drainage valve 44. Meanwhile, even in the case that the inverter 80 is not installed in the oxygen generator 15c, an AC power is supplied directly through the connector 81a as shown in FIG. 2.

Meanwhile, the oxygen separated from the oxygen separator 38 generates condensed water due to the variation in temperature and pressure when passing through the oxygen discharging tube.

The condensed water trap 42 collects the condensed water generated as described above and dispenses the collected condensed water. The detailed structure will be described with reference to FIG. 14. The condensed water drainage valve 44 provided on the lower portion of the condensed water trap 42 is a well-known solenoid valve which is opened and closed under the control of the controller 14.

The electric power supplied to the condensed water drainage valve 44 is interrupted by pressing the condensed water drainage button 76 provided on the control panel 12. That is, if the condensed water drainage button 76 is pressed, the electric power supplied to the condensed water drainage valve 44 under the control of the controller 14 is interrupted to thereby open the condensed water drainage valve 44. If the condensed water drainage button 76 is not pressed, the electric power is continuously supplied to the condensed water drainage valve 44 to thereby close the condensed water drainage valve 44.

In particular, when the engine of a vehicle stops, no electric power is supplied from a cigarette jack port 82, and thus no electricity is supplied to the condensed water drainage valve 44. The condensed water drainage valve 44 is automatically opened.

The oxygen separator 38 is a hollow thread film-type of an oxygen separator having a hollow thread film therein, or a flat film-type of an oxygen separator having a flat film therein. The hollow thread film-type oxygen separator or flat film-type oxygen separator is a well-known oxygen separator. When air is taken in and passes through the oxygen separator, oxygen is separated from the air that has been taken in. A gas other than oxygen is discharged into the outer air through a nitrogen discharging tube 20. Here, although the gas other than oxygen is not pure nitrogen, a majority of the gas is occupied by nitrogen. In this embodiment, the oxygen separated gas discharging tube is called a nitrogen discharging tube.

The oxygen supply device 10 according to an embodiment of the present invention has a comparatively simple operating mechanism in which air intake through the air inlet tube 16 passes through the oxygen separator 38 to produce oxygen, and the oxygen produced by the oxygen separator 38 passes through the condensed water trap 42 to remove water drops from the oxygen discharged through the oxygen discharging tube 18.

Meanwhile, since the controller 14 controls the first and second pumps 36 and 40, a pumping capacity of each pump can be controlled by the controller 14 to control the amount of oxygen produced.

Also, an aromatic diffuser 86 is provided on the end of the oxygen discharging tube 18.

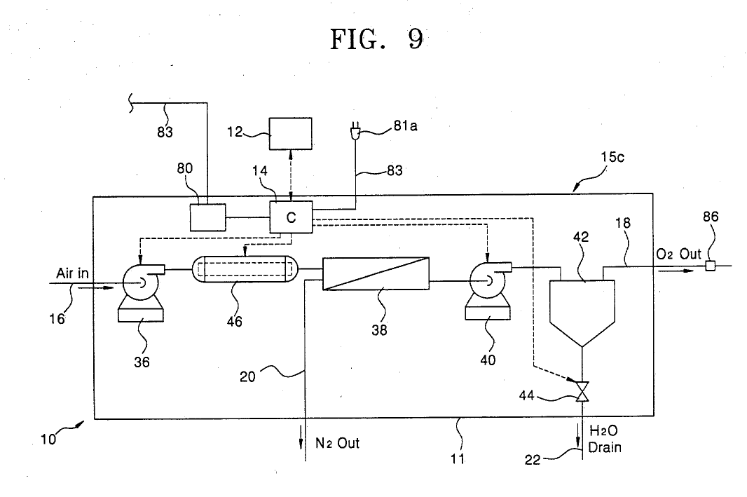

FIG. 9 is a schematic diagram for explaining the inner structure of another oxygen generator in each of the oxygen supply devices according to the first and second embodiments of the present invention, differing from the FIG. 8 oxygen generator.

Referring to FIG. 9, an ultraviolet sterilizer 46 is additionally provided between the first pump 36 and the oxygen separator 38. The ultraviolet sterilizer 46 has at least one lamp emitting an ultraviolet ray having a sterilizing capability. Accordingly, the ultraviolet sterilizer 46 sterilizes various types of bacteria in the air flowing from the first pump 36 to the oxygen separator 38, enabling fresher oxygen to be discharged. The ultraviolet sterilizer 46 is also controlled by the controller 14.

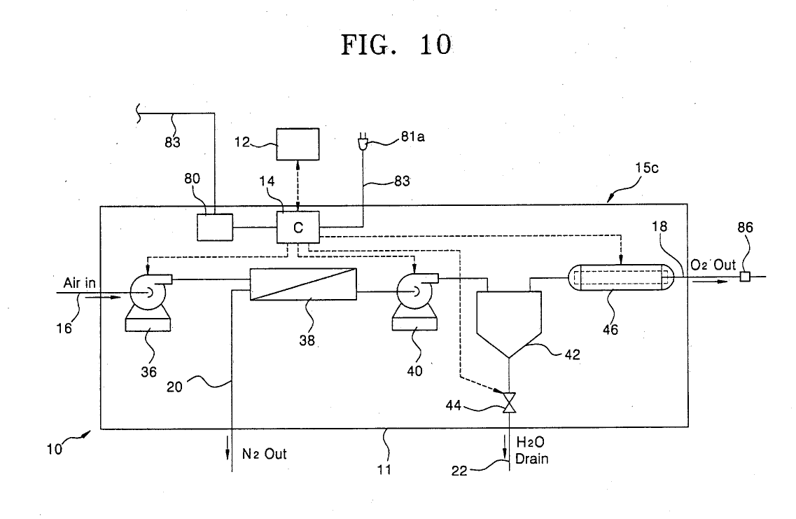

FIG. 10 is a schematic diagram for explaining the inner structure of still another oxygen generator in each of the oxygen supply devices according to the first and second embodiments of the present invention, differing from the FIG. 8 oxygen generator.

Referring to FIG. 10, an ultraviolet sterilizer 46 is installed between the condensed water trap 42 and the oxygen discharging tube 18. The ultraviolet sterilizer 46 is the same as that of FIG. 9, except that it sterilizes bacteria in the dried oxygen that has passed through the condensed water trap 42.

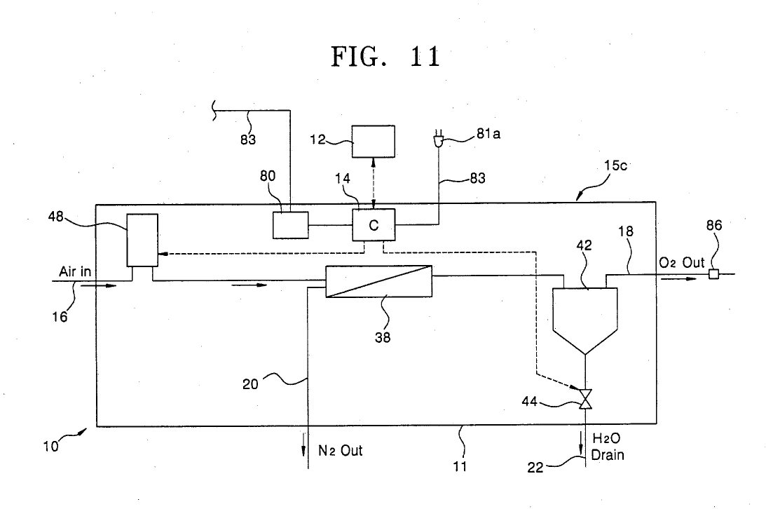

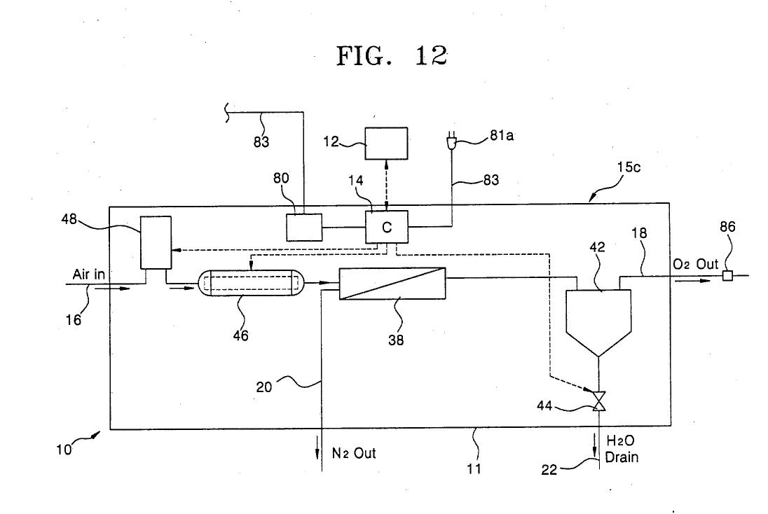

FIG. 11 is a schematic diagram explaining the inner structure of yet another oxygen generator in each of the oxygen supply devices according to the first and second embodiments of the present invention, differing from the FIG. 8 oxygen generator.

Referring to FIG. 11, a piston pump 48 is applied as a unit for intaking air from outside of the case 11 toward the oxygen separator 38. The piston pump 48 is a well-known pump having a cylinder and a piston reciprocating in the cylinder. The outside air through the air inlet tube 16 and is compressed and exhaled into the oxygen separator 38, to thereby enable the oxygen separator 38 to produce oxygen.

FIG. 12 is a schematic diagram explaining the inner structure of another oxygen generator in each of the oxygen supply devices according to the first and second embodiments of the present invention, differing from the FIG. 11 oxygen generator.

Referring to FIG. 12, an ultraviolet sterilizer 46 is provided between the piston pump 48 and the oxygen separator 38. The ultraviolet sterilizer 46 sterilizes various germs in the air when the air that has been taken in passes through the oxygen separator 38 from the piston pump 48, thereby enabling the oxygen separator 38 to produce fresher oxygen.

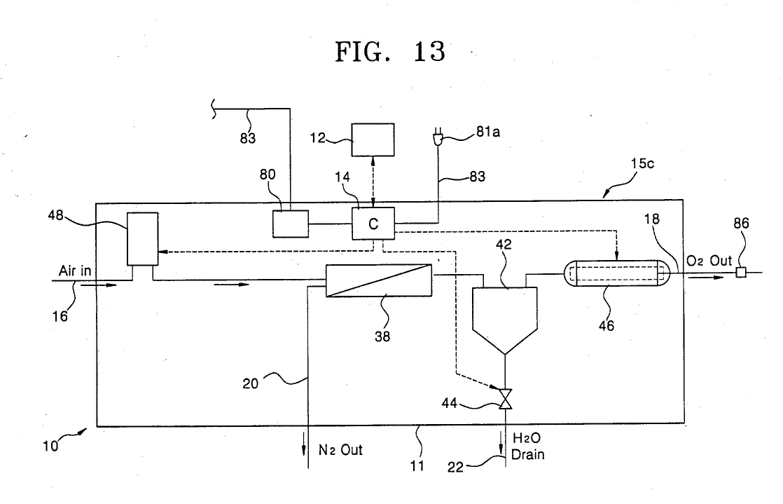

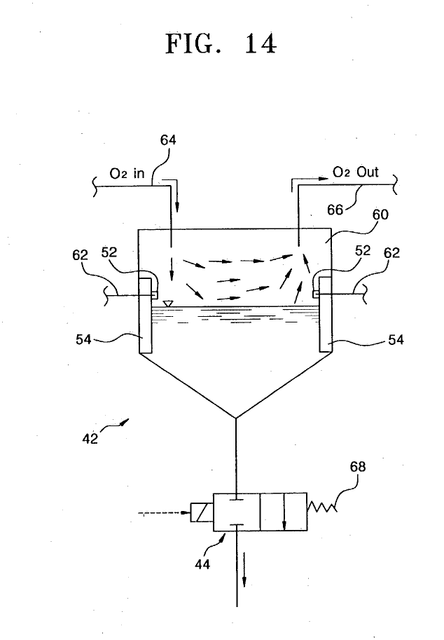

FIG. 13 is a schematic diagram explaining the inner structure of still another oxygen generator in each of the oxygen supply devices according to the first and second embodiments of the present invention, differing from the FIG. 11 oxygen generator.

Referring to FIG. 13, an ultraviolet sterilizer 46 is installed between the condensed water trap 42 and the oxygen discharging tube 18. The dried oxygen that has passed through the condensed water trap 42 passes through the ultraviolet sterilizer 46 to then be sterilized into fresher oxygen and supplied to a place requiring oxygen.

FIG. 14 is a schematic diagram explaining the structure of a condensed water trap installed in the oxygen supply device respectively shown in FIGS. 8 to 13.

Referring to FIG. 14, the condensed water trap 42 includes a container 60 providing a space to temporarily store condensed water therein, electrode supporters 54 installed opposite to one another on the inner wall surface of the container 60, and electrodes 52 installed opposite to one another in the electrode supporters 54 and at the identical height from the bottom of the container 60.

Also, an inlet tube 64 and an exit tube 66 are provided on the upper portion of the container 60. The inlet tube 64 is connected to the oxygen separator 38, for introducing oxygen into the container 60, and the exit tube 66 induces the dried oxygen that has passed through the container 60 toward the oxygen discharging tube 18.

Meanwhile, the electrodes 52 are well-known sensing units for detecting the level of condensed water collected in the container 60. As soon as the level of the condensed water collected in the container 60 reaches the height of the electrodes 52, the electrodes 52 are connected in circuitry by the water, which is conductive, thereby detecting whether the water level has reached the height of the electrodes 52.

The sensed result of the electrodes 52 is monitored by a warning lamp 74 on the control panel 12 via a cable 62. As a result, a driver can open the condensed water drainage valve 44 to drain the condensed water. In order to drain the condensed water, the condensed water drainage button 76 provided on the manipulator 12 is pressed to interrupt an electric power supplied to the condensed water trap 42, as described above.

The condensed water drainage valve 44 provided on the lower portion of the container 60 is a valve for draining the condensed water collected in the container 60 and operates under the control of the controller 14. However, the condensed water drainage valve 44 can be designed to operate manually.

The condensed water drainage valve 44 is a well-known two-port-two-position shift valve which is designed to be closed when electric power is supplied from an external power source, thereby preventing the condensed water from draining, and opened when electric power is not supplied from the external power source, thereby enabling the condensed water to be drained.

Thus, when a driver manipulates the control panel 12 to interrupt electric power supplied to the condensed water drainage valve 44, the condensed water drainage valve 44 is opened by an elastic force of a spring 68 to drain the condensed water. In particular, when the engine of a vehicle stops as described above, the electric power is not supplied to the condensed water drainage valve 44. As a result, although a driver may forgot to empty the condensed water, the condensed water is automatically drained when the engine of the vehicle stops.

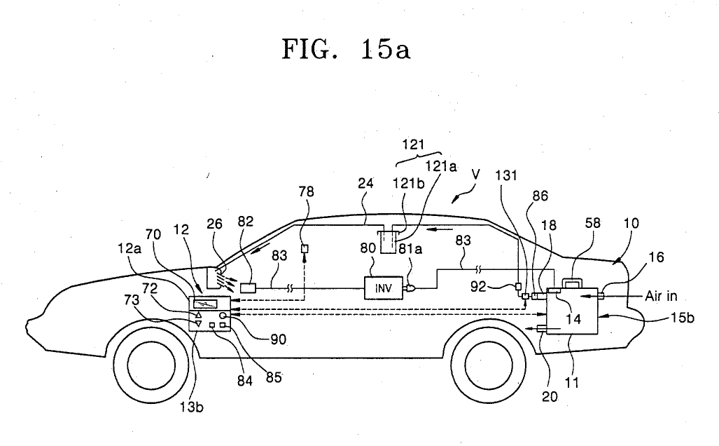

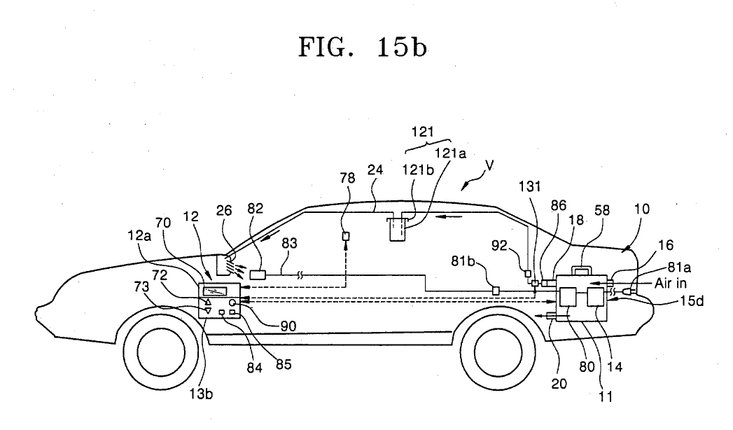

FIGS. 15A and 15B are schematic configurational diagrams showing examples when each oxygen supply device according to the third and fourth embodiments of the present invention is applied to a vehicle.

FIG. 15A shows an oxygen supply device having a power supply mode shown in FIG. 2, and FIG. 15B shows an oxygen supply device having a power supply mode shown in FIG. 3. In addition, as will be described later, since condensed water is not produced in the oxygen generators 15b and 15d, a condensed water drainage button, a warning lamp, or a condensed water drainage tube are not provided therein.

Referring to FIG. 15A, a display window 70 is provided on a display 12a in a control panel 12. desired oxygen concentration input buttons 72 and 73, a set button 84, a reset button 85, and a heater on/off button 90 are provided on a manipulator 13b. In particular, the heater on/off button 90 provided on the manipulator 13b is a button for determining whether a heater provided in a case 11 of each of oxygen generators 15b and 15d is turned on or off.

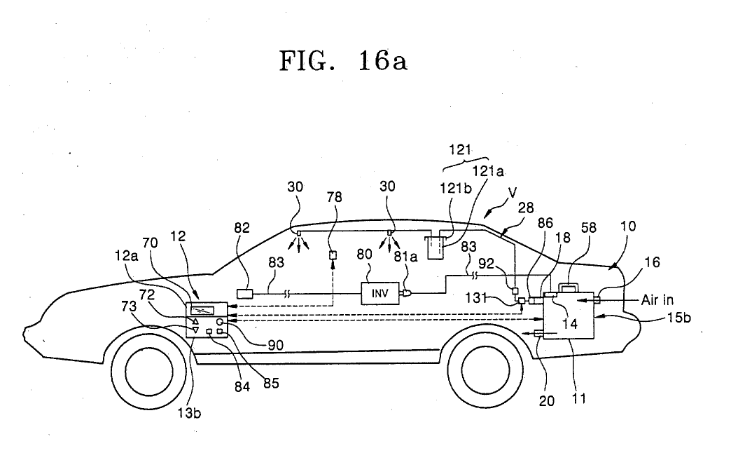

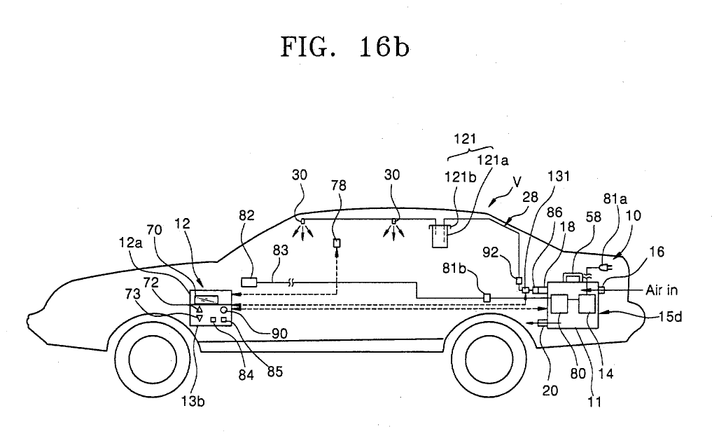

FIGS. 16A and 16B are schematic configurational diagrams showing other examples when each oxygen supply device according to the third and fourth embodiments of the present invention is applied to a vehicle. FIG. 16A shows an oxygen supply device having a power supply mode shown in FIG. 2, and FIG. 16B shows an oxygen supply device having a power supply mode shown in FIG. 3.

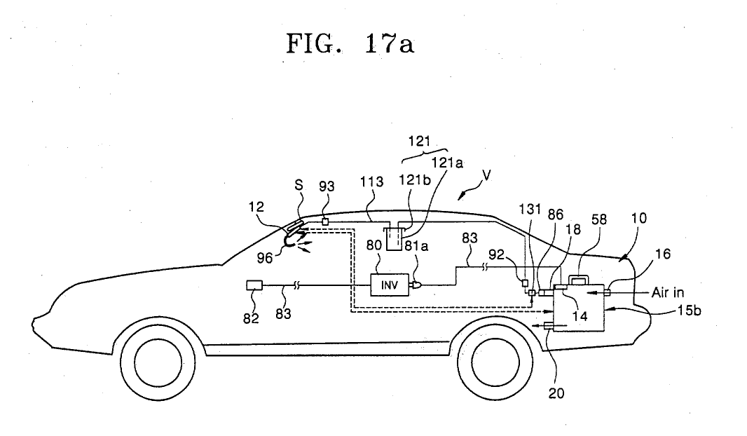

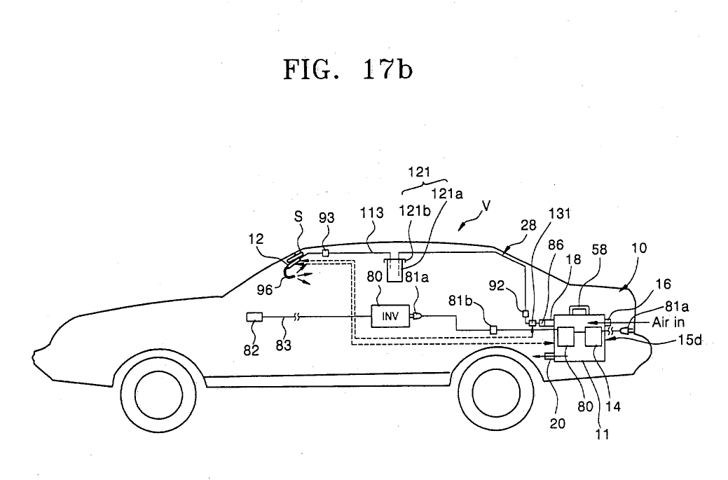

FIGS. 17A and 17B are schematic configurational diagrams showing still other examples when each oxygen supply device according to the third and fourth embodiments of the present invention is applied to a vehicle. FIG. 17A shows an oxygen supply device having a power supply mode shown in FIG. 2, and FIG. 17B shows an oxygen supply device having a power supply mode shown in FIG. 3.

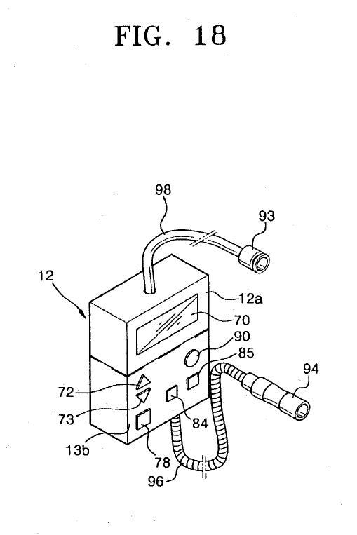

FIG. 18 is a detailed diagram showing a control panel respectively shown in FIGS. 15A to 17B.

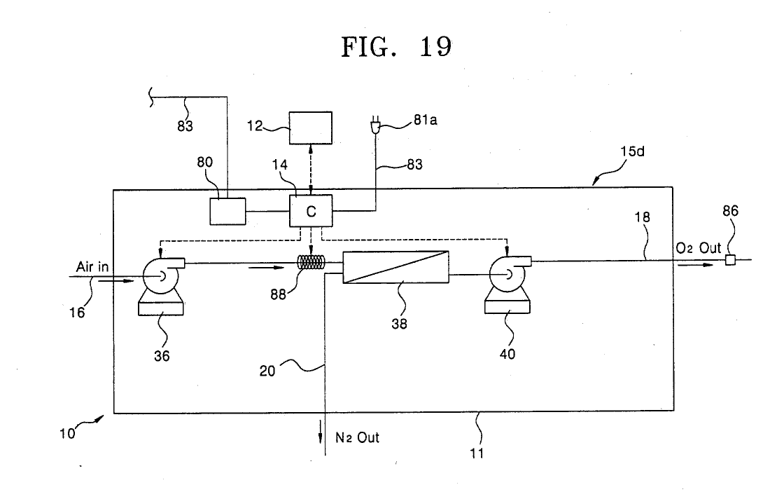

Referring to FIG. 18, a control panel 12 includes a display 12a and a manipulator 13b. A heater on/off button 90 is provided on the manipulator 13b. The heater on/off button 90 to be described later with reference to FIGS. 19 through 24 is a manipulation button for turning a heater on or off.

FIG. 19 is a schematic diagram explaining the inner structure of an oxygen generator in each of the oxygen supply devices according to the third and fourth embodiments of the present invention.

An oxygen supply device according to these embodiments of the present invention is based on a concept which is capable of preventing condensed water from being produced if air is heated prior to generating oxygen even if a pressure of oxygen is varied during an oxygen separating process.

Also, a power supply mode supplied to the oxygen generator 15d adopts a mode described with reference to FIG. 3. Except for an inverter 80, the structure of the FIG. 19 oxygen generator is the same as that of the oxygen generator shown in FIG. 2.

Referring to FIG. 19, a condensed water trap 42 does not exist in the oxygen generator 15d of the oxygen supply device according to a fourth embodiment of the present invention. Instead, a heater 88 is provided in the oxygen generator 15d. The heater 88, which is controlled by the controller 14, and heats air moving toward the oxygen separator 38, to thereby prevent condensed water from being produced due to a variation in pressure and temperature occurring when air passes through the oxygen separator 38.

The oxygen separated by the oxygen separator 38 is transferred directly to the oxygen discharging tube 18 via the second pump 40 and then transferred to a place requiring oxygen via an aromatic diffuser 86. Here, the oxygen separated air is discharged to the atmosphere via a nitrogen discharging tube 20.

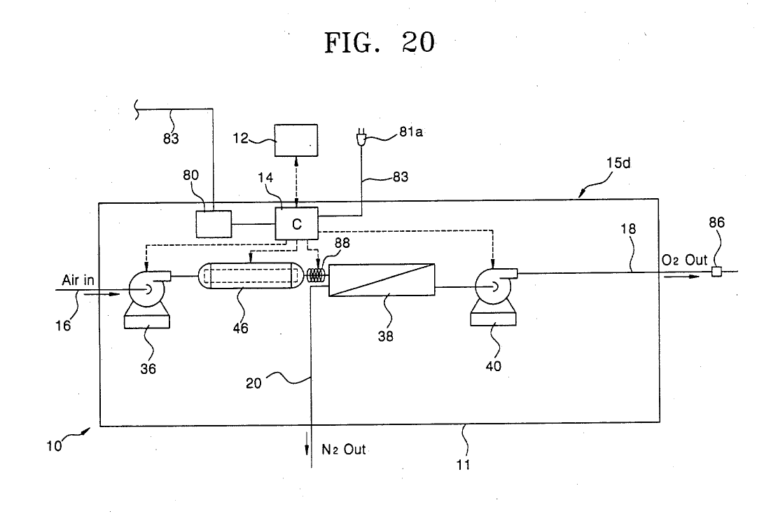

FIG. 20 is a schematic diagram explaining the inner structure of still another oxygen generator in each of the oxygen supply devices according to the third and fourth embodiments of the present invention, differing from the FIG. 19 oxygen generator.

Referring to FIG. 20, an ultraviolet sterilizer 46 is provided between a first pump 36 and a heater 88.

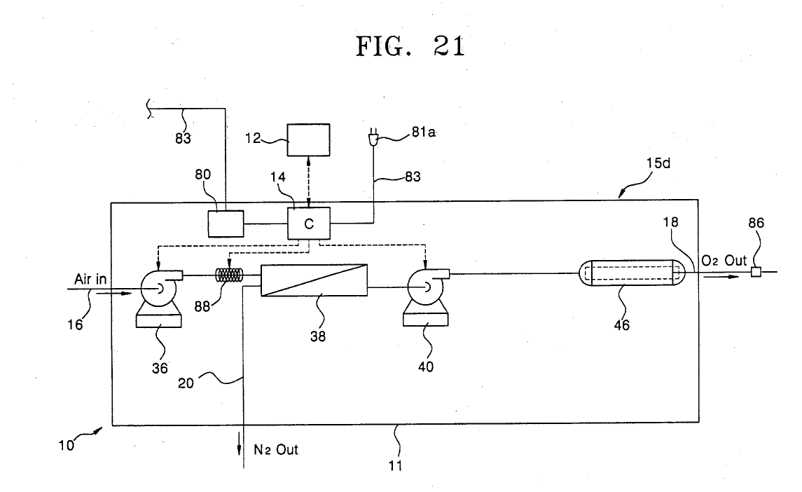

FIG. 21 is a schematic diagram explaining the inner structure of yet another oxygen generator in each of the oxygen supply devices according to the third and fourth embodiments of the present invention, differing from the FIG. 19 oxygen generator.

Referring to FIG. 21, an ultraviolet sterilizer 46 is provided between a second pump 40 and an oxygen discharging tube 18. The ultraviolet sterilizer 46 sterilizes bacteria from the oxygen separated from the air, so that sterilized oxygen is discharged outside of the case 11 via the oxygen discharging tube 18.

FIG. 22 is a schematic diagram explaining the inner structure of another oxygen generator in each of the oxygen supply devices according to the third and fourth embodiments of the present invention, differing from the FIG. 19 oxygen generator.

Referring to FIG. 22, a piston pump 48 is installed in order to move the air from outside of a case 11 toward an oxygen separator 38. A heater 88 is provided between the piston pump 48 and the oxygen separator 38.

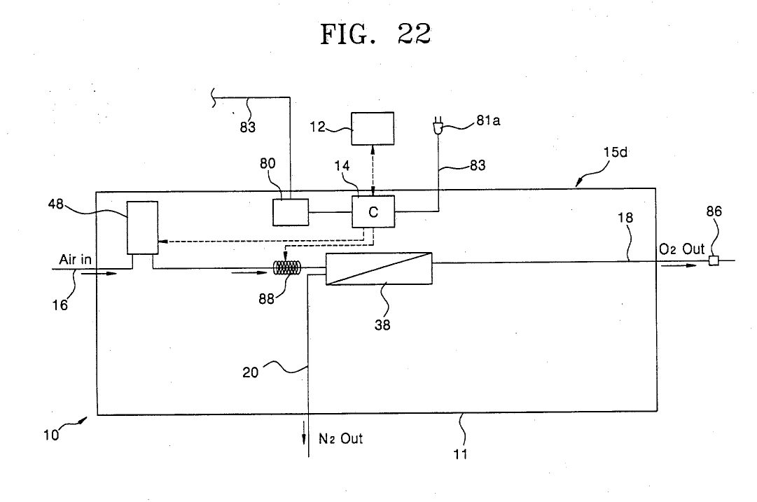

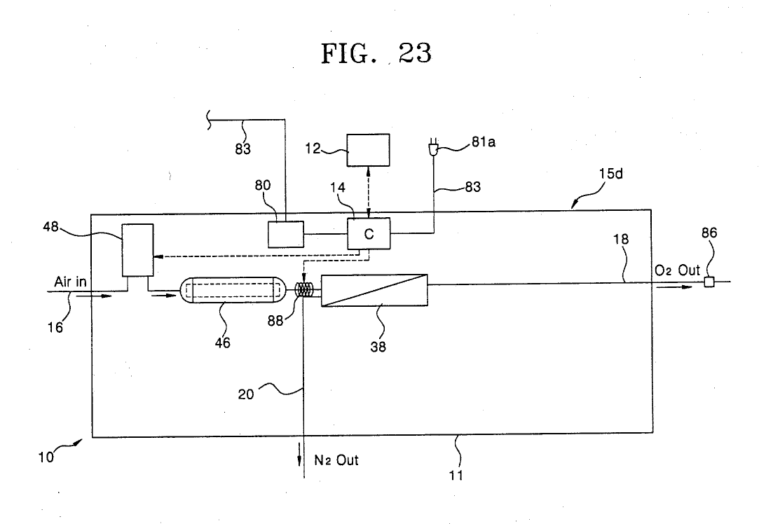

FIG. 23 is a schematic diagram explaining the inner structure of still another oxygen generator in each of the oxygen supply devices according to the third and fourth embodiments of the present invention, differing from the FIG. 19 oxygen generator.

Referring to FIG. 23, an ultraviolet sterilizer 46 is additionally provided between the piston pump 48 and the heater 88 in the oxygen generator 15d shown in FIG. 22.

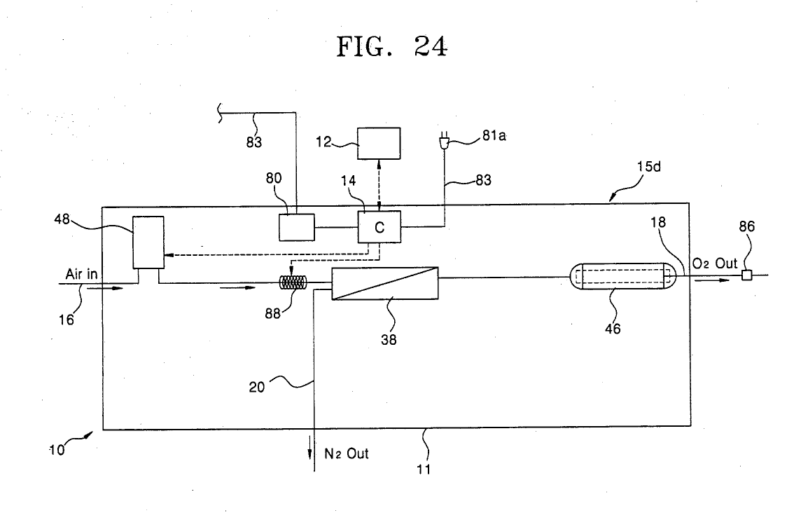

FIG. 24 is a schematic diagram explaining the inner structure of yet another oxygen generator in each of the oxygen supply devices according to the third and fourth embodiments of the present invention, differing from the FIG. 19 oxygen generator.

Referring to FIG. 24, an ultraviolet sterilizer 46 is additionally provided between the oxygen separator 38 and the oxygen discharging tube 18 in the oxygen generator 15d shown in FIG. 22.

FIGS. 25A and 25B are schematic configurational diagrams showing examples when each oxygen supply device according to first through fourth embodiments of the present invention is applied indoors, other than a vehicle.

FIG. 25A shows an oxygen supply device having a power supply mode shown in FIG. 2, and FIG. 25B shows an oxygen supply device having a power supply mode shown in FIG. 3.

Referring to FIGS. 25A and 25B, an oxygen discharging unit 109 is fixed to any one place on a wall inside a house H. The oxygen discharging unit 109 discharges oxygen and can be modified in various shapes in order to discharge oxygen.

An oxygen discharging tube 18 of each of oxygen generators 15a and 15b is connected to an oxygen supply line 115 via a connector 92. The oxygen generated from each of the oxygen generators 15a and 15b flows upwards through the oxygen supply line 115 and is sprayed from an oxygen discharging unit 109.

In addition, an oxygen concentration sensed by a discharged oxygen concentration sensor 131 provided in the oxygen discharging tube 18 is displayed on a display via a control panel 12.

A connector 81a which provides electric power to the control panel 12 is connected to an outlet (not shown) mounted on a wall, so that AC power is supplied directly to the control panel 12.

In particular, a connector 81 b which applies DC power to an inverter 80 provided in each of the oxygen generators 15c and 15d shown in FIG. 25B is not connected to any one outlet, that is, it is in a standby state.

Also, a control panel 12 and an oxygen concentration sensor 78 for sensing an indoor oxygen concentration are provided on another wall indoors. The control panel 12 can be hung on a wall via a well-known hookup unit. In particular, it is preferable that the control panel 12 is positioned at a user's eye level to thereby provide a user with ease recognizing a displayed result with the naked eye. Also, the oxygen concentration sensor 78 is preferably positioned at a user's eye level.

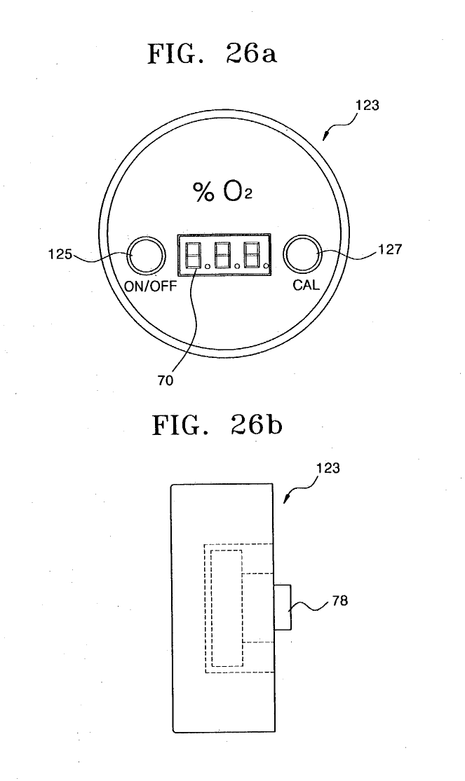

FIGS. 26A and 26B are detailed diagrams showing another control panel which can be applied to an oxygen supply device of the present invention. The control panel shown in FIGS. 26A or 26B has a simpler configuration, and provides a simpler function than that shown in FIGS. 7A or 18.

As shown in FIGS. 26A and 26B, a display window 70 is provided at the center on the front surface of a control panel 123. A power on/off button 125 is positioned on the left-hand side of the display window 70. Also, a calibration button 127 is provided on the right-hand side of the display window 70.

The power on/off button 125 is a general power on/off button for turning a controller 14 on or off. Also, the calibration button 127 performs a correction function matching a desired oxygen concentration stored in the controller 14 with a reference oxygen concentration. Here, the reference oxygen concentration is an oxygen concentration that can theoretically provide users with the most comfort, and is an oxygen concentration stored in the controller 14, and the desired oxygen concentration is a user's desired oxygen concentration which is newly input into the controller 14 when an oxygen supply device is in use.

The reference oxygen concentration is an invariable value stored in the RAM of a computer, and the desired oxygen concentration is a user's set value so that an oxygen supply device produces oxygen of the reference oxygen concentration.

Thus, the desired oxygen concentration and the reference oxygen concentration are initially the same. However, a desired oxygen concentration can differ greatly from a reference oxygen concentration due to a mechanical defect or other reasons when the oxygen supply device is used for an extended period of time.

Referring to FIG. 26B, an oxygen concentration sensor 78 is provided on the rear surface of a control panel 123. The oxygen concentration sensor 78 senses an indoor oxygen concentration and transfers the same to a display window 70 so as to be displayed thereon.

As described above, the present invention has been described with respect to the particularly preferred embodiments, but the present invention is not limited in the above-described embodiments. It is apparent to one of ordinary skill in the art that there are many variations and modifications that can be made within the scope of the appended claims without departing from the spirit of the present invention.

What is claimed is:

1. An oxygen supply device comprising: an oxygen generator installed in a case having an air inflow inlet and an oxygen discharging outlet,
wherein said oxygen generator comprises:
a pump for receiving outside air through the air inflow tube and pumping the air flowing in the air inflow tube, after being activated by an applied external power source;
an oxygen separator connected to the pump, where air discharged from the pump passes and oxygen is separated and generated from the air to thereby discharge the generated oxygen through the oxygen discharging tube;
a wet oxygen prevention unit for preventing water drops from being discharged through the oxygen discharging tube; and
a controller for controlling the pump and the wet oxygen prevention unit.

2. The oxygen supply device of claim 1, further comprising an oxygen concentration sensor for sensing an indoor oxygen concentration when oxygen produced from the oxygen generator is supplied and a display connected to the oxygen concentration sensor, for displaying the sensed oxygen concentration thereon.

3. The oxygen supply device of claim 2, wherein a percentage value of an oxygen concentration ratio of a current oxygen concentration with respect to a desired oxygen concentration is displayed on the display.

4. The oxygen supply device of claim 2, further comprising a manipulator for sending a control signal to the controller so as to perform a predetermined control operation.

5. The oxygen supply device of claim 4, wherein said manipulator and said display are connected with each other to form a control panel, in which a desired oxygen concentration input button for inputting a desired oxygen concentration into the controller is provided on the manipulator and at least one display window for displaying an oxygen concentration thereon is provided on the display.

6. The oxygen supply device of claim 4, wherein said wet oxygen prevention unit comprises:
a condensed water trap through which oxygen separated by the oxygen separator passes for separating condensed water generated due to a variation in oxygen pressure from the passing oxygen to thereby transfer the moisture removed oxygen to the oxygen discharging tube; and
a condensed water drainage valve, which is closed when power is applied thereto and is open when power is not applied thereto, for dispensing the condensed water collected in the condensed water trap.

7. The oxygen supply device of claim 4, wherein said wet oxygen prevention unit is a heater which is installed between the pump and the oxygen separator, for heating the air flowing into the oxygen separator so as to prevent condensed water from being produced due to the oxygen pressure variation.

8. The oxygen supply device of claim 1, further comprising a second pump which is installed between the oxygen separator and the oxygen discharging tube, for taking in the oxygen discharged from the oxygen separator and transferring the oxygen that has been taken in to the oxygen discharging tube.

9. The oxygen supply device of claim 1, further comprising at least one ultraviolet sterilizer for sterilizing bacteria in the air or oxygen in the oxygen supply device so that the oxygen discharged through the oxygen discharging tube is purified.

10. The oxygen supply device of claim 1, wherein an oxygen supply line for transferring oxygen to a place where oxygen is needed is connected to the oxygen discharging tube.

11. The oxygen supply device of claim 10, wherein said oxygen-supply line is configured so that an end of the oxygen supply line is extended into an air discharging grill to thereby discharge oxygen through the grill when the oxygen supply device is applied to a vehicle.

12. The oxygen supply device of claim 10, wherein said oxygen supply line comprises at least one diffusion nozzle which is installed on a ceiling at a driver's side, for spraying oxygen downwards, when the oxygen supply device is applied to a vehicle.

13. The oxygen supply device of claim 5, wherein an oxygen supply line for transferring oxygen to a place where oxygen is needed is connected to the oxygen discharging tube and wherein the oxygen supply line is configured so that an end of the oxygen supply line is extended toward a sun visor at the upper portion in front of a driver's seat to thereby discharge oxygen from the sun visor, in which the oxygen concentration sensor is installed on the control panel.

14. The oxygen supply device of claim 11, wherein a second condensed water trap for collecting and dispensing the condensed water produced inside of the oxygen supply line is further provided in a predetermined place along the oxygen supply line.

15. The oxygen supply device of claim 5, wherein said control panel is fixed to the sun visor and an end of the oxygen supply line is fixed to the control panel.

16. The oxygen supply device of claim 15, wherein an end of the oxygen supply line passes through the inside of the control panel and is connected to a flexible tube with which a discharging direction of oxygen can be adjusted in a desired direction.

17. The oxygen supply device of claim 6, wherein said manipulator further comprises a warning lamp for informing a user that the condensed water should be dispensed from the condensed water trap and a condensed water drainage button for disconnecting power applied to the condensed water drainage valve through the controller to thereby open the condensed water drainage valve.

18. The oxygen supply device of claim 7, wherein said manipulator further comprises a heater on/off button for turning the heater on or off via the controller.

19. The oxygen supply device of claim 1, wherein the power applied to the controller in the oxygen generator is a commercialized alternating-current (AC) power.

20. The oxygen supply device of claim 19, wherein an inverter for inverting an externally supplied direct-current (DC) power into an AC power is further provided in the oxygen supply device when the oxygen supply device is applied to a vehicle.

21. The oxygen supply device of claim 1, wherein said oxygen separator is a hollow thread-film or flat-film oxygen separator.

22. The oxygen supply device of claim 2, wherein a discharged oxygen concentration sensor for sensing a concentration of the oxygen discharged through the oxygen discharging tube and transferring the sensed oxygen concentration to the controller so as to be displayed on the display is provided in a place along the oxygen discharging tube in the oxygen generator.
